(19) United States
(12) Patent Application Publication
(10) Pub. No.: US 2026/0291153 A1
(43) Pub. Date: Sep. 24, 2026

(54) CONNECTOR STATUS INDICATOR MODULE AND CONNECTOR

(71) Applicants: TE Connectivity Solutions GmbH, Schaffhausen (CH); Tyco Electronics (Shanghai) Co., Ltd., Shanghai (CN)

(72) Inventors: Minghui Shao, Shanghai (CN); Deepan Ponraj Muthupandi, Bangalore (IN); Kun Tang, Shenzhen (CN); Weifeng Bian, Shanghai (CN); Yongyao Cai, Malden, MA (US); Yongjian (Justin) Huang, Shanghai (CN); Zhimin Zhang, Shanghai (CN)

(73) Assignees: TE Connectivity Solutions GmbH, Schaffhausen (CH); Tyco Electronics (Shanghai) Co., Ltd., Shanghai (CN)

(21) Appl. No.: 19/571,862

(22) Filed: Mar. 19, 2026

(30) Foreign Application Priority Data
Mar. 19, 2025 (CN) 202510331170.6

(51) Int. Cl. H01R 13/717; H01R 13/641

(52) U.S. Cl. CPC H01R 13/7175; H01R 13/641

(57) ABSTRACT

A connector status indicator module includes a circuit board, an indicator light, and two contact members. The indicator light is installed on the circuit board. The two contact members are each installed on the circuit board and are respectively electrically connected to a positive pole and a negative pole of the indicator light through conductive traces on the circuit board. The connector status indicator module is inserted into a housing of a connector. The two contact members respectively electrically contact two terminals of the connector. The indicator light emits light under a drive of an electrical signal transmitted by the two terminals to indicate a working status of the connector.

### CROSS-REFERENCE TO RELATED APPLICATION

This application claims the benefit of the filing date under 35 U.S.C. § 119(a)-(d) of Chinese Patent Application No. CN 202510331170.6 filed on Mar. 19, 2025, the whole disclosure of which is incorporated herein by reference.

### FIELD OF THE INVENTION

The present invention relates to a connector status indicator module and, more particularly, to a connector status indicator module for indicating the working status of a connector, and a connector comprising the connector status indicator module.

### BACKGROUND OF THE INVENTION

Typically, in order to display the working status of the connector, it is necessary to first use a main control board to collect electrical signals transmitted from terminals of the connector, and then the main control board drives LED lights to emit light based on the collected electrical signals. If the customer wants to add the indication function on the main control board, they must modify the main control board and adjust the corresponding electrical connection structure, which leads to higher costs. Typically, a signal acquisition harness needs to be set between the main control board and the connector, and a connection harness needs to be set between the main control board and the LED lights, resulting in high costs.

### SUMMARY OF THE INVENTION

A connector status indicator module includes a circuit board, an indicator light, and two contact members. The indicator light is installed on the circuit board. The two contact members are each installed on the circuit board and are respectively electrically connected to a positive pole and a negative pole of the indicator light through conductive traces on the circuit board. The connector status indicator module is inserted into a housing of a connector. The two contact members respectively electrically contact two terminals of the connector. The indicator light emits light under a drive of an electrical signal transmitted by the two terminals to indicate a working status of the connector.

### BRIEF DESCRIPTION OF DRAWINGS

The invention will now be described by way of example with reference to the accompanying figures, of which:

FIG. 1 is a front perspective view of a connector status indicator module according to an exemplary embodiment;

FIG. 2 is a back perspective view of the connector status indicator module of FIG. 1;

FIG. 3 is a back exploded view of the connector status indicator module of FIG. 1;

FIG. 4 is a perspective view of the connector status indicator module of FIG. 1 and a terminal electrical contact of a connector according to an exemplary embodiment;

FIG. 5 is a perspective view of the connector of FIG. 4;

FIG. 6 is an exploded view of the connector of FIG. 4;

FIG. 7 is an exploded sectional view of the connector of FIG. 4;

FIG. 8 is a cross-sectional view of the connector of FIG. 4, where a holder has not yet been installed onto a housing;

FIG. 9 is a cross-sectional view of the connector of FIG. 4;

FIG. 10 is a perspective view of the holder of FIG. 8; and

FIG. 11 is a perspective view of a connector according to another exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

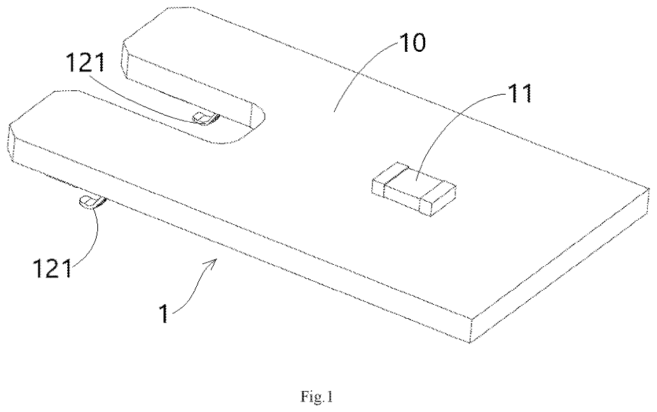

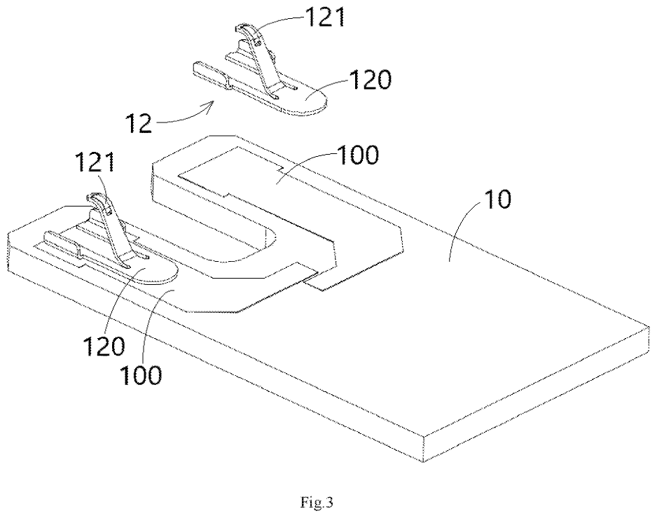

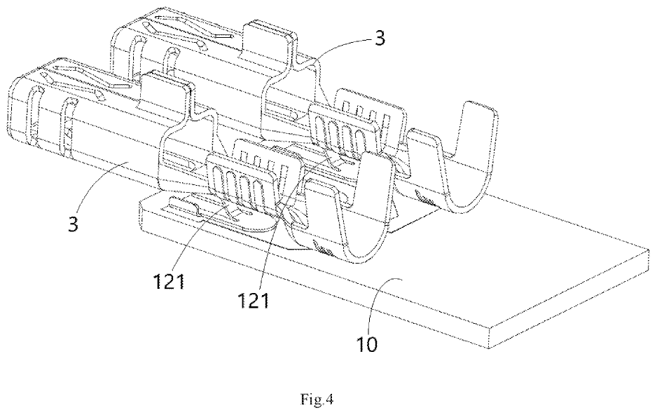

An exemplary embodiment of a connector status indicator module 1 will now be described. The connector status indicator module 1 includes a circuit board 10, as shown in FIGS. 1-4 and 6-9, an indicator light 11, as shown in FIGS. 1 and 6-8, and two contact members 12, as shown in FIG. 3. The indicator light 11 is installed on the circuit board 10. The two contact members 12 are installed on the circuit board 10 and electrically connected to the positive and negative poles of the indicator light 11 through conductive traces on the circuit board 10. The connector status indicator module 1 is suitable for insertion into a housing 2 of a connector, and the two contact members 12 are suitable for electrical contact with two terminals 3 of the connector respectively. The indicator light 11 is suitable for emitting light under the drive of the electrical signal transmitted by the two terminals 3 to indicate the working status of the connector.

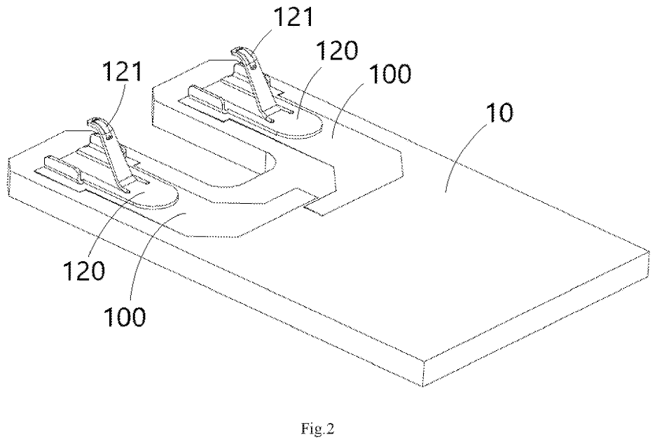

As shown in FIGS. 1-2, the circuit board 10 has opposite front and back surfaces in its thickness direction. The indicator light 11 is mounted on the front surface of the circuit board 10, and two contact members 12 are mounted on the back surface of the circuit board 10.

As shown in FIGS. 2-3, two pads 100 are formed on the circuit board 10. The two contact members 12 are respectively soldered onto the two pads 100 of the circuit board 10.

As shown in FIGS. 2-3, the contact member 12 includes a welding plate 120 and a cantilever part 121. The welding plate 120 is soldered onto the pad 100 of the circuit board 10. The cantilever part 121 is connected to the welding plate 120. The cantilever part 121 is used for electrical contact with the terminal 3. The contact member 12 can be an integral stamped part.

As shown in FIGS. 1 and 6-8, the indicator light 11 can be a surface mount LED light, which is soldered to the circuit board 10 in a surface mount manner.

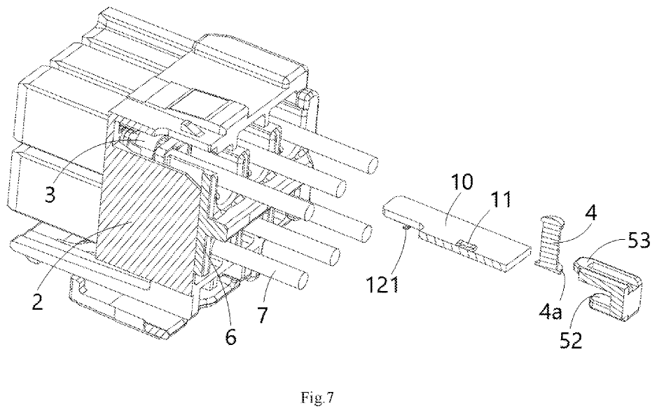

An exemplary embodiment of a connector will now be described with reference to FIGS. 1-10. As shown in FIG. 7, the connector includes a housing 2, multiple terminals 3, and the aforementioned connector status indicator module 1. The multiple terminals 3 are set in the housing 2. The connector status indicator module 1 is inserted into the housing 2. The two contact members 12 of the connector status indicator module 1 are in electrical contact with the two terminals 3 in the housing 2, respectively. The indicator light 11 is suitable for emitting light under the drive of the electrical signal transmitted by the two terminals 3 to indicate the working status of the connector.

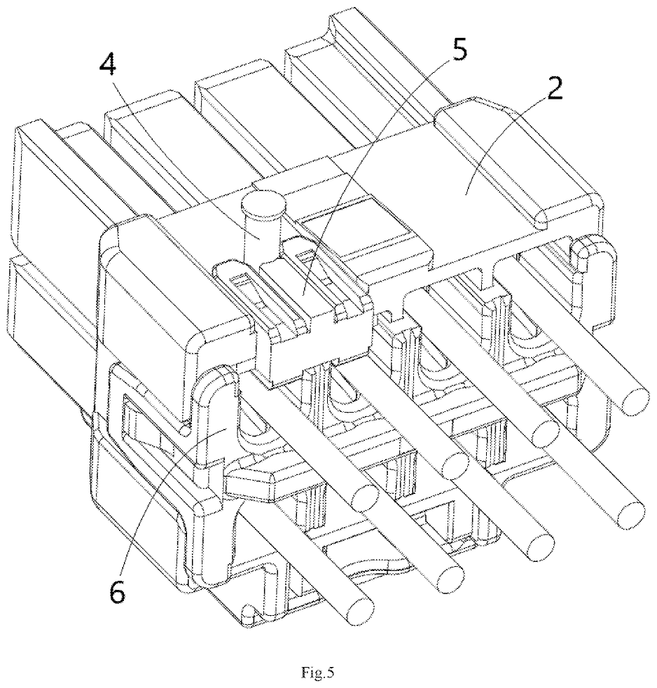

As shown in FIGS. 5-8, the connector further comprises a light guide tube 4, which is mounted on the housing 2. The light guide tube 4 has an inner end located in the housing 2 and in contact or adjacent to the indicator light 11, and an outer end located outside the housing 2, so that the light emitted by the indicator light 11 can be transmitted to the outside of the housing 2 through the light guide tube 4. In the illustrated embodiment, the light guide tube 4 is a straight light guide tube extending in a straight line. However, the present invention is not limited to this, for example, the light guide tube 4 can be a curved light guide tube bent into a predetermined shape.

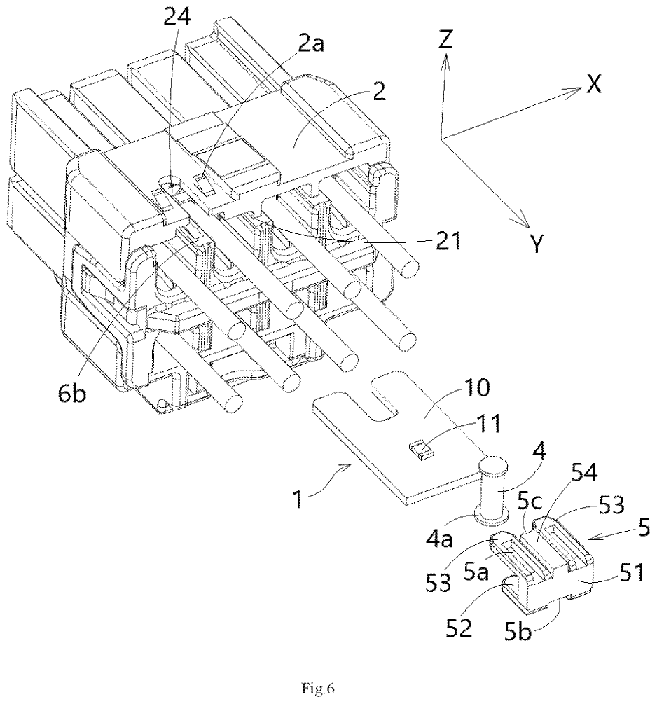

As shown in FIG. 6, a slot hole 24 is formed in the peripheral wall of the housing 2. The light guide tube 4 extends from the housing 2 through the slot hole 24. A limiting flange 4a, as shown in FIG. 6, is formed on the inner end of the light guide tube 4, which is adapted to rest against the inner side of the peripheral wall of the housing 2 to prevent the light guide tube 4 from being pulled out of the slot hole 24.

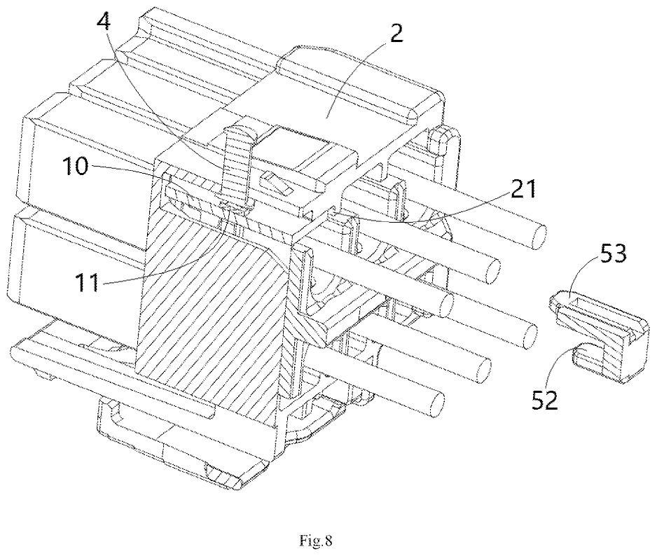

As shown in FIG. 8, the end face of the inner end of the light guide tube 4 faces the light-emitting surface of the indicator light 11 and is in contact with or adjacent to the light-emitting surface of the indicator light 11.

The present invention, however, is not limited to the illustrated embodiment. For example, in another exemplary embodiment of the present invention, a transparent window facing the indicator light 11 is formed on the housing 2, so that the light emitted by the indicator light 11 can be propagated to the outside of the housing 2 through the transparent window. In this way, the aforementioned light guide tube 4 can be omitted.

In another exemplary embodiment of the present invention, the housing 2 may be made of a transparent material, so that the light emitted by the indicator light 11 can be directly transmitted to the outside of the housing 2 through the housing 2. In this way, the aforementioned light guide tube 4 can also be omitted.

As shown in FIGS. 5-6, the connector further comprises a holder 5. The holder 5 is mounted to the housing 2 for holding the connector status indicator module 1 in a predetermined installation position.

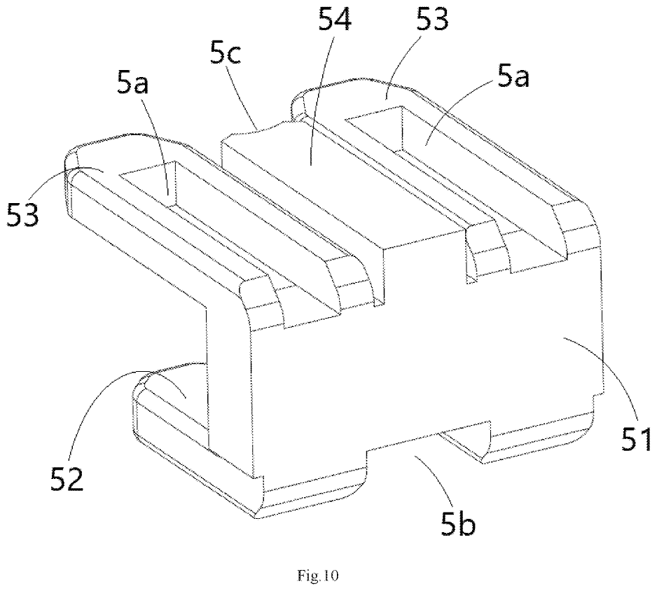

As shown in FIGS. 6 and 10, the holder 5 includes an end plate 51, a positioning plate 52, and an elastic buckle 53. The end plate 51 has a first side (lower side) and a second side (upper side) that are opposite in the height direction Z of the housing 2. The positioning plate 52 is connected to the first side of the end plate 51. The elastic buckle 53 is connected to the second side of the end plate 51. As shown in FIG. 6, a snap slot 5a is formed on the elastic buckle 53, and a protrusion 2a is formed on the outer side of the peripheral wall of the housing 2, which engages with the snap slot 5a of the elastic buckle 53 to lock the holder 5 to the housing 2. The positioning plate 52 is inserted into the housing 2, and the circuit board 10 of the connector status indicator module 1 is clamped between the positioning plate 52 and the peripheral wall of the housing 2 to keep the circuit board 10 in the predetermined installation position.

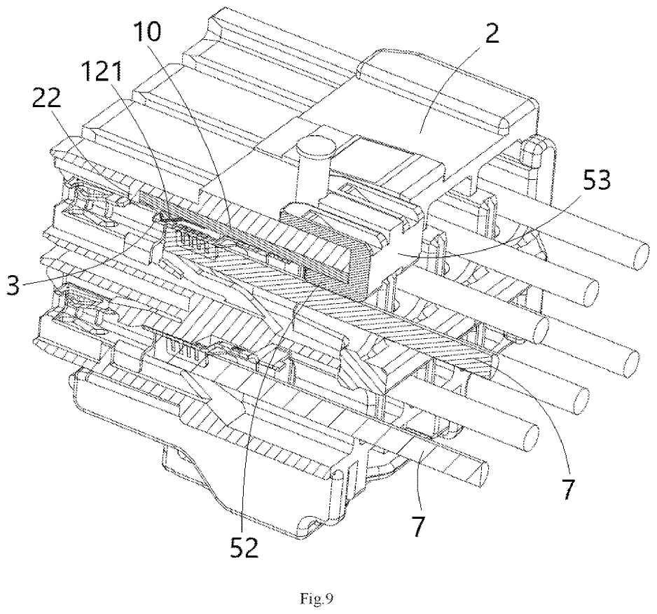

The circuit board 10 has left and right sides opposite in the transverse direction X of the housing 2, front and rear sides opposite in the longitudinal direction Y of the housing 2, and front and back surfaces opposite in the height direction Z of the housing 2. A limiting rib 21, as shown in FIGS. 6 and 8, and a limiting step 22, as shown in FIG. 9, are formed on the inner side of the peripheral wall of the housing 2. The limiting rib 21 abuts against the left or right side of the circuit board 10, and the limiting step 22 abuts against the front side of the circuit board 10. The end plate 51 is pressed against the rear side of the circuit board 10, the positioning plate 52 is pressed against the back surface of the circuit board 10, and the peripheral wall of the housing 2 is pressed against the front surface of the circuit board 10. This ensures that the circuit board 10 is positioned at the predetermined installation location.

As shown in FIGS. 6 and 10, the holder 5 further comprises a retaining plate 54 connected to the second side of the end plate 51 and arranged side by side with the elastic buckle 53. An arc-shaped positioning surface 5c is formed at the front end of the retaining plate 54, which is attached to the light guide tube 4 for holding the light guide tube 4 in a predetermined position.

As shown in FIGS. 5 and 7, the connector further comprises a locking component 6. The locking component 6 is inserted into the housing 2 for locking multiple terminals 3 in the housing 2. The locking component 6 has a partition rib 6b, as shown in FIG. 6, extending along the longitudinal direction Y of the housing 2, and a guide groove 5b, as shown in FIGS. 6 and 10, is formed on the positioning plate 52 of the holder 5. The guide groove 5b cooperates with the partition rib 6b to guide the holder 5 to be inserted into the housing 2 along the longitudinal direction Y and to position the holder 5 in the transverse direction X of the housing 2.

As shown in FIG. 7, multiple terminals 3 are arranged in two rows, top and bottom. The two contact members 12 of the connector status indicator module 1 are in electrical contact with adjacent terminals 3 in one row of terminals 3.

As shown in FIGS. 7 and 9, the connector further comprises multiple cables 7, which are respectively electrically connected to the rear ends of multiple terminals 3. The front end of terminal 3 is used to mate with a mating terminal of a mating connector.

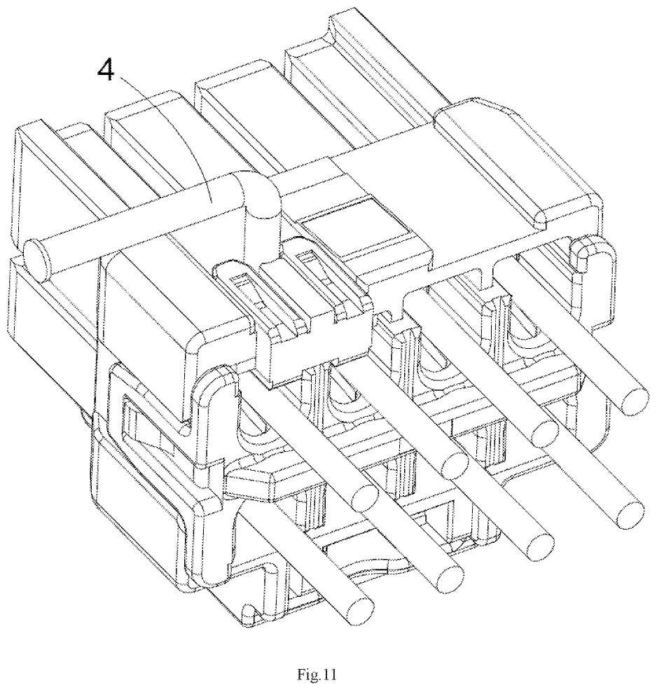

Another exemplary embodiment of a connector will now be described with reference to FIG. 11. The only difference between the connector shown in FIG. 11 and the connector shown in FIGS. 1-10 is the shape of the light guide tube 4. In the embodiment shown in FIG. 11, the light guide tube 4 can be bent into any suitable shape according to actual needs, for example, the light guide tube 4 can be, but is not limited to, an L-shaped, arc-shaped, U-shaped, or S-shaped light guide tube.

In the aforementioned exemplary embodiments according to the present invention, the connector status indicator module 1 is inserted into the housing 2 of the connector, directly in electrical contact with the terminals 3 of the connector, and drives the indicator light 11 to emit light directly using the electrical signal transmitted by the terminals 3. Therefore, the present invention does not require the use of connecting wire harnesses, has the advantages of high integration and simple installation, and can effectively reduce electrical signal attenuation, with strong anti-interference ability.

In addition, in the aforementioned exemplary embodiments according to the present invention, the light guide tube 4 can be designed into a suitable shape according to actual applications, and the connector status indicator module 1 can be inserted into the housing 2 of commonly used connectors. Therefore, the present invention can be applied to various application scenarios and connectors, and has strong universality.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector status indicator module, comprising:
a circuit board;
an indicator light installed on the circuit board; and
a pair of contact members each installed on the circuit board and respectively electrically connected to a positive pole and a negative pole of the indicator light through conductive traces on the circuit board, the connector status indicator module is inserted into a housing of a connector, the contact members respectively electrically contact a pair of terminals of the connector, the indicator light emits light under a drive of an electrical signal transmitted by the terminals to indicate a working status of the connector.

2. The connector status indicator module of claim 1, wherein the circuit board has a front surface and a back surface opposite each other in a thickness direction of the circuit board, the indicator light is mounted on the front surface of the circuit board, and the contact members are each mounted on the back surface of the circuit board.

3. The connector status indicator module of claim 1, wherein a pair of pads are formed on the circuit board, the contact members are respectively soldered onto the pads of the circuit board.

4. The connector status indicator module of claim 3, wherein at least one contact member includes a welding plate soldered onto one of the pads of the circuit board, and a cantilever part connected to the welding plate and electrically contacting one of the terminals.

5. The connector status indicator module of claim 4, wherein the at least one contact member is an integral stamped part.

6. The connector status indicator module of claim 1, wherein the indicator light is a patch type LED light surface mounted and soldered onto the circuit board.

7. A connector, comprising:
a housing;
a plurality of terminals arranged in the housing; and
a connector status indicator module including a circuit board, an indicator light installed on the circuit board, and a pair of contact members each installed on the circuit board and respectively electrically connected to a positive pole and a negative pole of the indicator light through conductive traces on the circuit board, the connector status indicator module is inserted into the housing, the contact members respectively electrically contact a pair of terminals of the plurality of terminals, the indicator light emits light under a drive of an electrical signal transmitted by the terminals to indicate a working status of the connector.

8. The connector of claim 7, further comprising a light guide tube installed onto the housing, the light guide tube has an inner end located in the housing and in contact or adjacent to the indicator light, and an outer end located outside the housing, such that the light emitted by the indicator light is propagated to the outside of the housing through the light guide tube.

9. The connector of claim 8, wherein the light guide tube is a straight light guide tube extending in a straight line.

10. The connector of claim 8, wherein the light guide tube is a curved light guide tube bent into a predetermined shape.

11. The connector of claim 10, wherein the light guide tube is an L-shaped, arc-shaped, U-shaped, or S-shaped curved light guide tube.

12. The connector of claim 8, wherein a slot hole is formed in a peripheral wall of the housing, the light guide tube extends from the housing through the slot hole, a limiting flange is formed on the inner end of the light guide tube, the limiting flange rests against an inner side of the peripheral wall of the housing to prevent the light guide tube from being pulled out of the slot hole.

13. The connector of claim 8, wherein an end face of the inner end of the light guide tube faces a light-emitting surface of the indicator light and is in contact or adjacent to the light-emitting surface of the indicator light.

14. The connector of claim 7, wherein a transparent window is formed on the housing facing the indicator light, the transparent window allows light emitted by the indicator light to propagate to an outside of the housing through the transparent window.

15. The connector of claim 7, wherein the housing is made of transparent material, such that light emitted by the indicator light is transmitted through the housing to an outside of the housing.

16. The connector of claim 8, further comprising a holder installed onto the housing and holding the connector status indicator module in a predetermined installation position.

17. The connector according to claim 16, wherein the holder has an end plate, a positioning plate, and an elastic buckle, the end plate has opposing first and second sides, the positioning plate is connected to the first side of the end plate, the elastic buckle is connected to the second side of the end plate, a snap slot is formed on the elastic buckle, a protrusion is formed on an outer side of a peripheral wall of the housing, the protrusion is engaged with the snap slot of the elastic buckle to lock the holder to the housing, the positioning plate is inserted into the housing, the circuit board of the connector status indicator module is clamped between the positioning plate and the peripheral wall of the housing to maintain the circuit board in the predetermined installation position.

18. The connector of claim 17, wherein the circuit board has a left side and a right side opposite in a transverse direction of the housing, a front side and a rear side opposite in a longitudinal direction of the housing, and a front surface and a back surface opposite in a height direction of the housing, a limiting rib and a limiting step are formed on an inner side of the peripheral wall of the housing, the limiting rib abuts against the left side or the right side of the circuit board, the limiting step abuts against the front side of the circuit board, the end plate is pressed against the rear side of the circuit board, the positioning plate is pressed against the back surface of the circuit board, and the peripheral wall of the housing is pressed against the front surface of the circuit board.

19. The connector of claim 17, wherein the holder further comprises a retaining plate connected to the second side of the end plate and arranged side by side with the elastic buckle, an arc-shaped positioning surface is formed at a front end of the retaining plate, the arc-shaped positioning surface is attached to the light guide tube and holds the light guide tube in a predetermined position.

20. The connector of claim 17, further comprising a locking component inserted into the housing, the locking component locks the plurality of terminals in the housing, the locking component has a partition rib extending along a longitudinal direction of the housing, a guide groove is formed on the positioning plate of the holder, the guide groove cooperates with the partition rib to guide the holder to be inserted into the housing along the longitudinal direction and to position the holder in a transverse direction of the housing.

21. The connector of claim 7, wherein the plurality of terminals are arranged in two rows, the contact members of the connector status indicator module are in electrical contact with adjacent terminals in one row of terminals.

22. The connector of claim 7, further comprising a plurality of cables respectively electrically connected to rear ends of the plurality of terminals, a front end of at least one terminal mates with a mating terminal of a mating connector.
